(19) United States
(12) Patent Application Publication
(10) Pub. No.: US 2007/0061375 A1
(43) Pub. Date: Mar. 15, 2007

(54) SYSTEM AND METHOD FOR MANAGING A PLURALITY OF DATABASE SYSTEMS

(76) Inventors: Douglas Brown, Rancho Sante Fe, CA (US); Anita Richards, San Juan Capistrano, CA (US)

Correspondence Address: James M. Stover;Intellectual Property Section, Law Department, NCR Corporation, 1700 South Patterson Blvd., Dayton, OH, 45479-0001, US

(21) Appl. No.: 11/468,107

(22) Filed: Aug. 29, 2006

Related U.S. Application Data
(60) Provisional application No. 60/715,815, filed on Sep. 9, 2005.

(51) Int. Cl. G06F 17/30

(52) U.S. Cl. 707/200

(57) ABSTRACT

A system for managing a plurality of database systems, the system including an interface for obtaining data indicative of one or more operational characteristics of each of the managed database systems, such as CPU usage, query response times and performance statistics; and a monitor that is responsive to the data for providing a signal indicative of an instruction to adjust one or more of the operational characteristics of a selected one of the database systems.

### CROSS REFERENCE TO OTHER APPLICATIONS

This application claims priority under 35 U.S.C. §119(e) to the following co-pending and commonly-assigned patent application, which is incorporated herein by reference: Provisional Application Ser. No. 60/715,815, entitled “A SYSTEM AND METHOD FOR MANAGING A PLURALITY OF DATABASE SYSTEMS,” filed on Sep. 9, 2005, attorney's docket number 12162.

This application incorporates by way of cross reference the subject matter disclosed in: U.S. patent application Ser. No. 10/730,348, filed Dec. 8, 2003, entitled Administering the Workload of a Database System Using Feedback, by Douglas P. Brown, Anita Richards, Bhashyam Ramesh, Caroline M. Ballinger and Richard D. Glick, NCR Docket No. 11167; U.S. patent application Ser. No. 10/786,448, filed Feb. 25, 2004, entitled Guiding the Development of Workload Group Definition Classifications, by Douglas P. Brown, Bhashyam Ramesh and Anita Richards, NCR Docket No. 11569; and U.S. patent application Ser. No. 10/889,796, filed Jul. 13, 2004, entitled Administering Workload Groups, by Douglas P. Brown, Anita Richards, and Bhashyam Ramesh, NCR Docket No. 11560, and U.S. patent application Ser. No. 10/915,609, filed Aug. 10, 2004, entitled Regulating the Workload of a Database System, by Douglas P. Brown, Anita Richards, and Bhashyam Ramesh, NCR Docket No. 11561.

### BACKGROUND

Any discussion of the prior art throughout the specification should in no way be considered as an admission that such prior art is widely known or forms part of common general knowledge in the field.

As database management systems (DBMS) continue to increase in function and expand into new application areas, the diversity of database workloads is increasing as well. In addition to the classic relational DBMS workload consisting of short transactions running concurrently with long decision support queries, workloads comprising of an even wider range of system demands are emerging. New complex data types, such as image files, audio files, video files and other large objects, and new active data warehouse requirements, such as capacity on demand, data replication, fault-tolerance, dual active query processing, recursion, user defined types (UDFs), external UDFs, and so on, result in widely varying memory, processor, disk and network demands on database systems.

In general, a DBMS has a number of operational characteristics. These include physical statistics, such as CPU usage, query response times and performance statistics. In some DBMS, the operational characteristics include rule sets under which the database operates, relating to the likes of resource consumption and request prioritization. Varying these rule sets often has an effect on other physical characteristics, for example altering performance statistics. Ideally, a DBMS should be able to accept performance goals for a workload and dynamically adjust its own performance based on whether or not these goals are being met. Closed-loop system management (CLSM) is a technology directed towards this ideal. Under some known CLSM-type systems, incoming queries are split into workload groups, each workload group having respective performance goals. The DBMS is responsive to these whether or not these goals are met for selectively switching between predetermined rule sets or adjusting performance controls.

It is known to operate multi-system environments, wherein a plurality of databases, database systems, or DBMS operate in parallel. For example: DBMS that use Massively Parallel Processing (MPP) architecture across multiple systems or a Symmetric Multiprocessing (SMP) architecture. In particular, it is known to operate a “dual-active” system wherein a plurality of databases operate in parallel and intercommunicate. For example, by way of inter process communication mechanisms such as TCP/IP, UDP, BYNET networks, and the like. It will be appreciated that managing complex workloads and performance goals performance objectives across the board in a multi-system environment is difficult.

### SUMMARY

It is an object of the present invention to overcome or ameliorate at least one of the disadvantages of the prior art, or to provide a useful alternative.

In accordance with a first aspect of the invention, there is provided a system for managing a plurality of database systems, the system including:
an interface for obtaining data indicative of one or more operational characteristics of each of the database systems; and
a monitor that is responsive to the data for providing a signal indicative of an instruction to adjust one or more of the operational characteristics of a selected one of the database systems.

In accordance with a second aspect of the invention, there is provided a method for managing a plurality of database systems, the method including the steps of:
obtaining data indicative of one or more operational characteristics of each of the database systems; and
being responsive to the data for providing an instruction to adjust one or more of the operational characteristics of a selected one of the database systems.

In accordance with a further aspect of the invention, there is provided method for administering the workload of a plurality of database systems as one or more requests are received by a management system, the method including:
sorting the one or more requests into one or more workload groups, each workload group having an associated level of service desired from the database system;
selecting a database system to process the or each request to achieve the levels of service associated with each of the workload groups;
executing the one or more requests to achieve the levels of service associated with each of the workload groups;
assigning system resources of one or more of the database systems to the one or more workload groups as necessary to provide the level of service associated with each workload group;
monitoring the execution of requests to detect a deviation from the level of service greater than a short-term threshold and, if such a deviation is detected:
   adjusting the assignment of system resources of one or more of the database systems to workload groups to reduce the deviation; and
monitoring on a long-term basis to detect deviations from the expected level of service greater than a long-term threshold, and if such a deviation is detected:
   adjusting the execution of requests to better provide the expected level of service.

### BRIEF DESCRIPTION OF THE DRAWINGS

The benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a system according to the invention.

FIG. 2 is schematic representation of a multi system regulator;

FIG. 3 is an architectural diagram of a multi-system regulator; and

FIG. 4 is a high level architectural flow diagram of a multi-system regulator receiving sub-system CLSM regulator information using a binary cascade tree.

### DETAILED DESCRIPTION

Referring to the drawings, it will be appreciated that, in the different figures, corresponding features have been denoted by corresponding reference numerals.

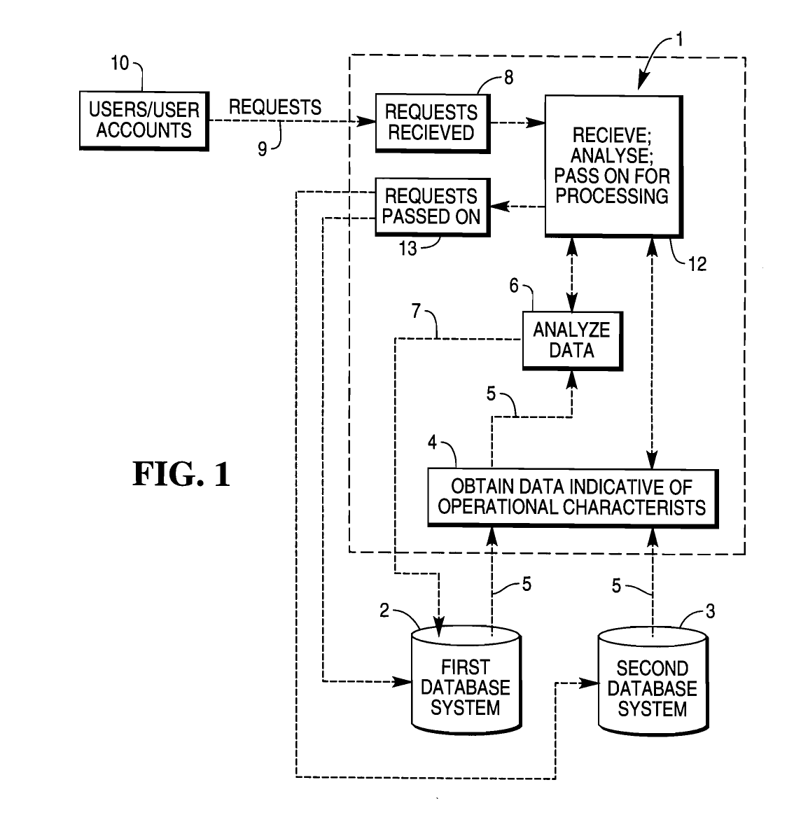

Referring initially to FIG. 1, there is provided a system 1 for managing a plurality of database systems, referred to as databases 2 and 3. System 1 includes an interface 4 for obtaining data 5 indicative of one or more operational characteristics of each of databases 2 and 3. A monitor 6 is responsive to the data 5 for providing a signal 7 indicative of an instruction to adjust one or more of the operational characteristics of a selected one of databases 2 and 3. In FIG. 1, for the sake of illustration, the selected database is database 2.

In the present disclosure, the term “database” is used in a general sense, and is meant to include the wider range of components used in conjunction with a database in a database system or DBMS. In some embodiments databases 2 and 3 are simple tables of data, whereas in other embodiments they include complex DMBS. For the sake of the present example, databases 2 and 3 are database systems that make use of CLSM-type architecture, and each includes a CLSM-type regulator. An example of such a database system is Teradata V2R6. Teradata is a trademark of NCR Corporation.

At a high level, system 1 operates as a feedback response mechanism for a domain defined by a plurality of databases. It is responsive to the performance of the domain insofar as database requests are preformed within predefined threshold requirements. System 1 is responsive to data indicative of this performance for adjusting settings, such as resource consumption rules and query prioritization settings. In many embodiments, this is used to better ensure that the available resources are utilized in a manner conducive to efficiently processing a variable workload.

It will be appreciated that the terms “workload class”, “workload group” and workload definition” are substantially synonymous. That is, the terms each relate to the same general identification structure used to separate requests for prioritization, processing and performance monitoring in a CLSM database system.

In the present example, each of databases 2 and 3 analyze its performance and inherently adjusts its respective operational characteristics in response to the analysis. The analysis includes determining whether a particular class of queries are processed in accordance with one or more service level goals (SLGs) assigned to that class of queries. It will be appreciated that, in the present embodiment, this is achieved through the CLSM architecture of database 2 and 3. In brief, each database separates incoming queries into workload groups in accordance with predefined principles. Each workload group has assigned to it one or more respective service level goals (SLGs). The database maintains logs and obtains data to determine whether or not SLGs are being met for particular workload groups, and makes adjustments to operational characteristics in response. The typical objective is to adjust available settings such that the SLGs are met. This commonly includes using throttles and/or a query delay manager to adjust arrival rates of queries.

The precise nature of how workload groups are defined and settings adjusted is generally beyond the scope of the present disclosure, and various aspects are dealt with is detail in the cross-referenced applications.

Other embodiments are used with databases that use alternate architectures to analyze their performance and inherently adjust their respective operational characteristics in response to the analysis.

In the present example, operational characteristics include performance statistics, rule sets under which a database is operating, physical attributes, and so on. Some particular examples are set out below.
Memory—the amount of system and subsystem memory currently being used. It is possible that the system will include some memory that is shared among all of the subsystems.
The number of available AMP worker tasks (AWTs). An AWT is a thread or task within an AMP for performing the work assigned by a dispatcher. Each AMP has a predetermined number of AWTs in a pool available for processing. When a task is assigned to an AMP, one or more AWTs are assigned to complete the task. When the task is complete, the AWTs are released back into the pool. As an AMP is assigned tasks to perform, its available AWTs are reduced. As it completes tasks, its available AWTs are increased.
FSG Cache—the amount of FSG cache that has been consumed. The FSG cache is physical memory that buffers data as it is being sent to or from the data storage facilities.
Arrival rates—the rate at which requests are arriving. Arrival rates are often broken down and used as a resource management tool on a workload basis. Typically, throttles are used to delay the processing of queries and thereby adjust arrival rates.
Co-existence—the co-existence of multiple types of processors and or processor types. For example, a where first node runs on a 386 processor and others run on 486 or 586 processors.
Skew—the degree to which data (and therefore processing) is concentrated in one or more AMPs as compared to the other AMPs.
Blocking/locking—the degree to which data access are blocked or locked because other processes are accessing data.
Spool—the degree of consumption of disk space allocated to temporary storage.
Disk failures, such as clique failures.
Node failures.

System 1 includes an input 8 for receiving a request 9 from a user 10. Although user 10 is illustrated as a person, it will be appreciated that various hardware and software devices also provide requests 9.

Request 9 is typically a database query, such as a tactical query. In the present embodiment databases 2 and 3 define a dual-active domain. As such, either of databases 2 and 3 is capable of handling a request 9. Despite this, it will be appreciated that one of the databases is often able to handle a request 9 more efficiently given its operational characteristics. As such, a processor 12 is responsive to interface 4 for selecting one of databases to process a received request 9. An output 13 provides the request the selected database for processing. In FIG. 1 output 13 is shown to be providing requests to both database 2 and database 3. This is meant to illustrate the provision of at least two discrete requests, and not a single request being provided to both databases. In the present embodiment, output 13 provides request 9 in accordance with a predetermined query prioritization protocol, such as that administered by an implementation of Teradata Priority Scheduler Facility (PSF) or a similar component. Monitor 6 adjusts this predetermined query prioritization protocol in response to data 5. For example in an embodiment where PSF is used, monitor 12 adjusts the PSF settings such a class weights in accordance with the functionality of a standard Teradata CLSM regulator.

Processor 12 categorizes the request into one of a plurality of predetermined workload groups. As previously mentioned, each workload group has respective SLGs. These SLGs relate to response times and the like—generally levels of service that are expected from databases 2 or 3 in the processing of a request 9. In determining which database should be selected to process a request 9, processor 12 is responsive to operational characteristics that indicate ability of a particular database to process a request belonging to a particular workload group in accordance with the service level goals of that workload group. For example, each database is operated under one of a group of predetermined system resource consumption rules sets. Processor 12 is initiated to recognize a particular rule set as being particularly suited to handling a certain workload mix.

As a simple example, consider two generic exemplary workload groups—tactical queries and background queries. A rule set A is most suitable for handling tactical queries, and a rule set B is most suitable for handling background queries. For the sake of the example, interface 5 has obtained data indicative of database 2 operating under rule set A, and database 3 operating under rule set B. A tactical query is received by interface 4, and recognized as a tactical query by processor 12. Processor 12 is then responsive to interface 4 for selecting database 2 to process that tactical query.

The above example is over simplistic to a degree. In some circumstances, interface 4 obtains other operational characteristics of database 2 that suggest it is not meeting SLGs for tactical queries, in spite of the local CLSM regulator's operation. In such a case, processor 12 selects database 3 for the tactical query. In practical terms, tactical queries are directed to database 3 until interface 4 obtains data to which processor 12 is responsive for altering the procedure.

In some circumstances interface 4 obtains operational characteristics of databases 2 and 3—such as AMP worker task (AWT) congestion—and in response throttles queries to adjust request arrival rates until the AWT resources become available. It will be appreciated that CLSM architecture supports the ability to delay incoming requests using a query delay manager and/or delay queue.

Monitor 6 is responsive to processor 12 for providing a signal 7. Using the above example, when processor 12 begins to send a stream of tactical queries to database 3, the workload mix of database 3 changes. As such, rule set B is not necessarily the optimal choice—in the present example a rule set C is more suitable. In such a case, monitor 6 takes the pro-active step of sending a signal 7 to database 3, and in response database 3 adapts for operation under rules set C.

Processor 12 is responsive to whether SLGs for requests 9 are being met across the domain defined collectively by databases 2 and 3. To this end, monitor 6 takes on a functionality similar to that of a CLSM regulator and adjusts operational characteristic such as rule sets for either or both of databases 2 and 3. It will be appreciated that this assists in the provision of a domain wide approach to workload administration.

It will be appreciated that, at a high level, system 1 functions in a similar manner to a CLSM regulator. That is, it monitors on a short-term basis the execution of requests to detect a deviation from the SLGs, and where a sufficient deviation is detected the assignment system resources to particular workload groups across the plurality of databases is adjusted to reduce the deviation.

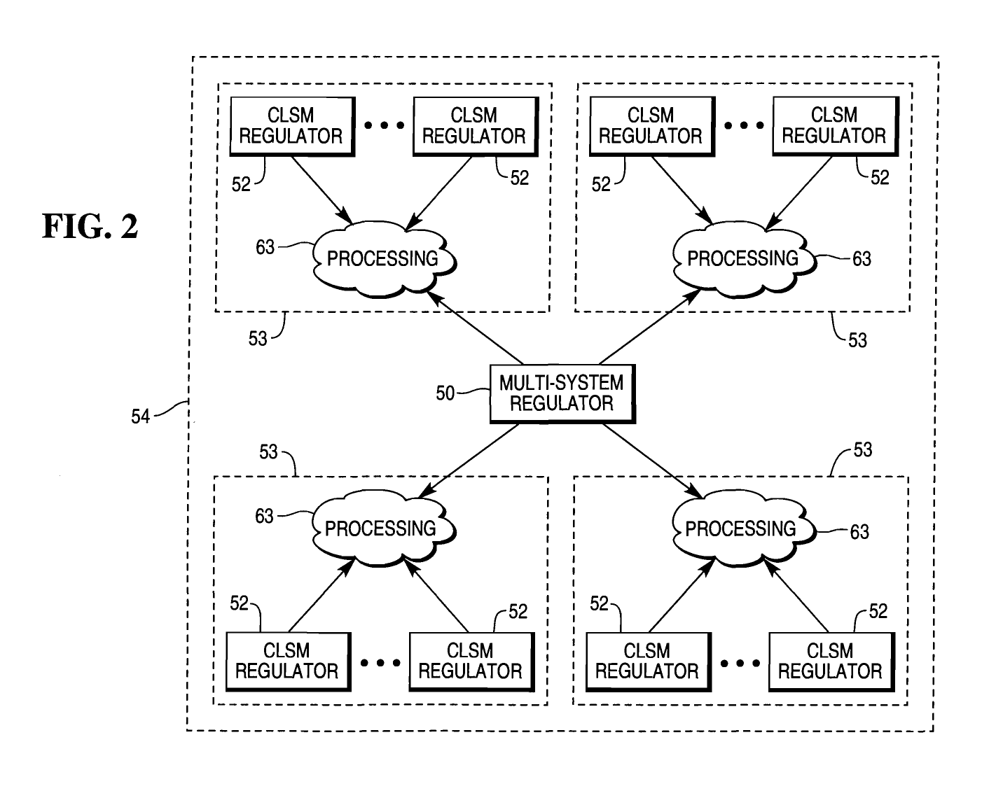

Referring to FIGS. 2, 3 and 4, embodiments will now be described with reference to a plurality of dual-active Teradata V2R6 databases. The embodiment makes use of various Teradata components, such as Teradata Workload Analyzer and Priority Scheduler Facility. Those skilled in the art will recognize that similar embodiments are implemented using alternate hardware and software components.

Managing system resources on the basis of individual systems and requests does not, in general, satisfactorily manage complex workloads and SLGs across a domain of databases in a multi-system environment. To automatically achieve workload goals across multi-systems, performance goals must first be defined across the domain and managed and regulated across the domain.

Teradata's CLSM functionality is known to manage workloads on an individual system basis. Under the present embodiment, a modified CLSM analyzer and CLSM regulator are implemented to enhance the known CLSM architecture. That is, by extending the functionality of the CLSM-administrator and CLSM regulator components in accordance with the general notions of system 1, complex workloads are manageable across a domain. The modified CLSM regulator is in the form of a multi-system regulator 50. The function of regulator 50 is to control and manage existing CLSM regulators 52 across all sub-systems 53 in a domain 54. The new functionality extends the existing CLSM goal oriented workload management infrastructure, which is capable of managing various types of workloads.

Although FIG. 2 depicts an implementation using a single regulator 50 for the entire domain 54, in some exemplary systems one or more backup regulators 50 are also provided for circumstances where the primary multi-system regulator malfunctions.

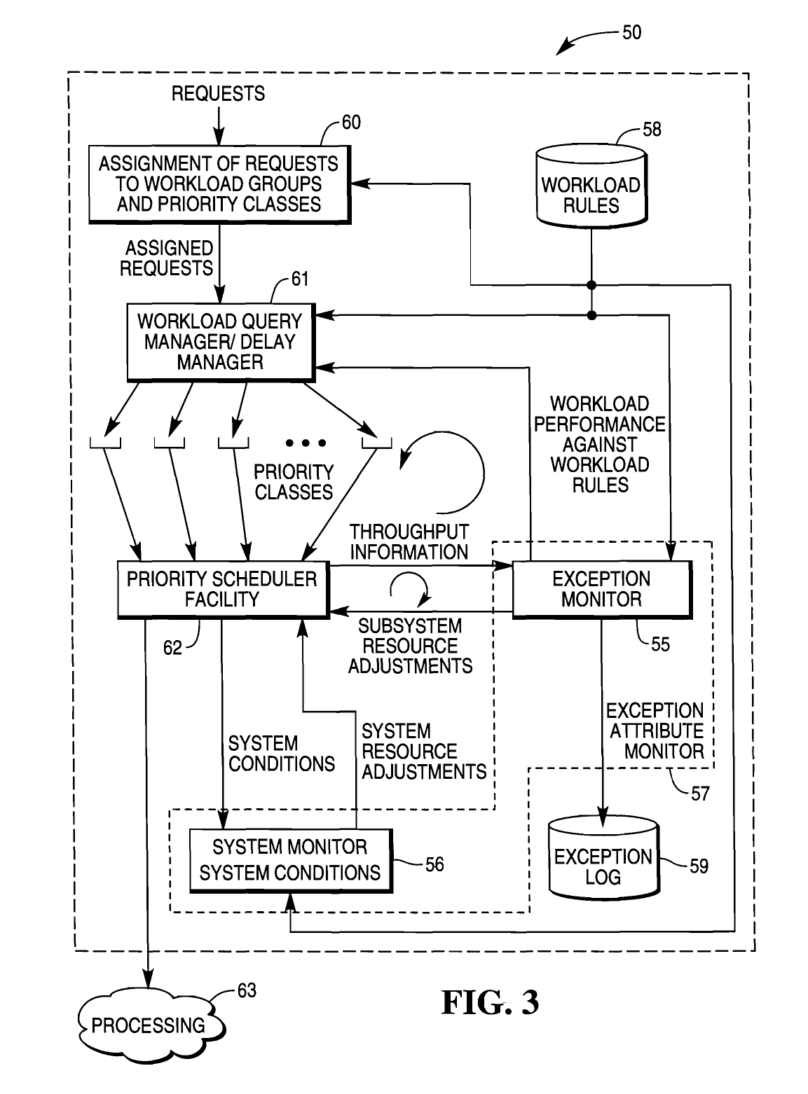

Referring to FIG. 3, multi-system regulator 50 includes an exception monitor 55 for detecting workload exceptions, which are recorded in a log 59. For example, recorded exceptions typically include such things as CPU and I/O exceeding known predetermined thresholds. A system condition monitor 56 is provided to detect system conditions—such as node failures. These collectively define an exception attribute monitor 57.

In practice, regulator 50 receives requests, and assigns these into their respective workload groups and priority classes at 60. The assigned requests are then passed through a workload query manager, also known as a delay manager at 61. The delay manager provides throttling functionality. In particular, it is responsive to workload rules 58 and exception monitor 55 for either passing a request on or placing it in a queue until predetermined conditions are met. It will be appreciated that this allows for arrival rates to be adjusted. If passed, the requests are split into their priority classes for handling by PSF 62. PSF 62 is responsive to the priority classes for providing the requests in accordance with predefined principles for processing at 63. These principles are updated over time in response to system monitor 56 and exception monitor 55. PSF reports observed system conditions to monitor 56 and throughput information to monitor 55, which are responsive to such information for updating the principles under which PSF operates.

Each regulator 52 uses a set of user-defined rules, or heuristics, to guide a feedback mechanism that manages the throughput of a workload for each workload group defined in the Teradata system. In general, multi-system regulator 50 provides a single view of managing workloads and the associated rules across multiple systems. Meanwhile, regulators 52 continue to support workloads in a Closed Loop System Environment running on each sub-system 53 defined in domain 54.

Multi system regulator 50 manages PSF settings and workload groups by controlling sub-system CLSM regulators and/or adjusting workload rules in order to achieve SLGs. It also monitors operational characteristics such as system conditions, exceptions, system failures, workload exceptions and the like. Further, it controls the amount of work allowed into each subsystem 53 to meet SLGs across domain 54.

Regulator 50 gathers system resource information by broadcasting to all regulators 52 in domain 54 a request that they report their current resource consumption. This will be recognized as the functionality of interface 4 in the previous example.

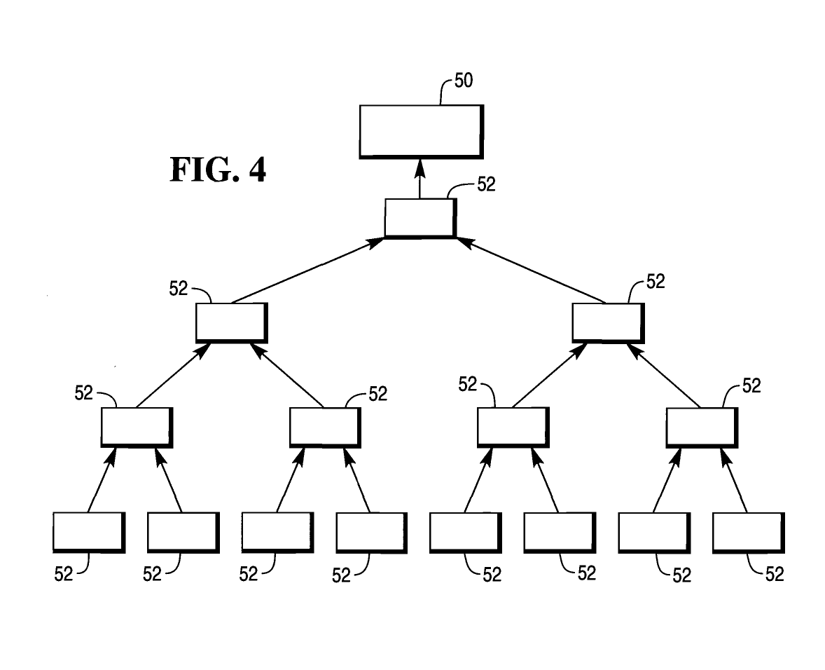

In some embodiments each subsystem 53 has its own subsystems, and so on. An example of this is shown in FIG. 4, which illustrates a binary tree structure. In such embodiments, each regulator 52 gathers information related to its resource consumption, as well as that of its children regulators 52, and reports the aggregated compiled resource consumption information to its parent regulator 52, or regulator 50 in the case for first level regulators 52. In some cases each regulator 52 waits until it has received resource consumption information from its children before forwarding the compiled resource consumption information to its parent. In that way, the resource consumption information is compiled from the bottom of the tree to the top. When regulator 50 compiles its resource consumption information with that which is reported by all of regulators 52, it will have complete system conditions and resource consumption information for domain 54. Regulator 50 will analyze the aggregated information to apply resource consumption rules and make resource adjustments based on multiple sets of system information.

In the example shown in FIG. 4, the tree is a binary tree. It will be understood that other types of trees will fall within the scope of this broad invention. In particular: n-ary trees in a broader context. Further, while the tree in FIG. 4 is symmetrical, symmetry is not a limitation. Indeed, the example of FIG. 4 is provided for the purposes of convenient representation only, and is not intended to be limiting in any way.

In another example system, each regulator 52 communicates its resource consumption information directly to the regulator 50. Regulator 50 compiles the information, adds system level resource consumption information—to the extent there is any—and makes its resource adjustments based on the resulting set of information.

Each CLSM regulator 52 monitors and controls, in a closed loop fashion, workload performance information for a single subsystem 53. For example, this includes throughput information received from a dispatcher processor. The performance information is compared to SLGs 58. In the example of throughput information, the level of desired throughput defined in SLGs 58 is compared to the actual level of throughput occurring for a particular workload. Multi system regulator 50 then adjusts resource allocation weights to better meet the workload rules.

Multi-system regulator 50 receives system conditions from the sub-system CLSM regulators 52, and compares the conditions to the SLGs. In response regulator 50 adjusts the system resource allocation weights to better meet the system conditions.

In another example, multi-system regulator 50 receives system conditions from sub-system regulators 52, and compares the known arrival rates to the system conditions. In response, regulator 50 adjusts the arrival rates by adjusting throttling values to better meet the system conditions.

Generally speaking, regulators 52 provide real-time closed-loop control over subsystem resources, the loop having a fairly narrow bandwidth—typically the order of milliseconds, seconds, or minutes. Regulator 50 provides real-time closed-loop control over domain 54, the loop having a much larger bandwidth—typically the order of minutes, hours, or days.

Further, while regulators 52 controls subsystem resources and regulator 50 controls system resources across the domain, in many cases subsystem resources and system resources are the same. The multi-system regulator has a higher level view of the state of the system wide resources because it is aware, at a higher level of the state of resources of all subsystems, while each CLSM regulator is generally only aware of the state of its own resources.

There are a number of techniques by which regulator 50 implements its adjustments to the allocation of system resources. For example, and as illustrated in FIG. 2, regulator 50 communicates adjustments directly to regulators 52. Regulators 52 then apply the relevant rule adjustments. Alternatively, regulator 50 communicates adjustments to regulators 52 by passing them down a tree, such as that in FIG. 4. In either case, regulators 52 incorporate resource rule adjustments ordered by regulator 50 in the various subsystems.

Regulator 50 is adaptable for use where regulators 52 include on either or both of a Teradata Database nodes and a non-Trusted Parallel Nodes—such as a node running UNIX, Linux or Windows. It will be appreciated that in cases where non-Trusted Parallel Nodes are involved, regulator 50 effectively adopts its inherent CLSM-type approach across non CLSM-type database systems. That is, although a particular database system that includes a regulator 52 does not inherently operate under CLSM, when under the influence of regulator 50 is does to an extent.

These techniques for communication between the regulators 50 and 52 are accomplished by various methods, which will be recognized by those skilled in the art. For example: running a single process across all of the nodes and all of the dispatchers, by multiple processes where each process executes on a separate PE, or by processes that can run on more than one, but not all, of the PEs.

Given that regulator 50 has access to the resource consumption information from all of regulators 52, it can make resource adjustments that are mindful of meeting the system workload rules. It is capable of, for example, adjusting the resources allocated to a particular workload group on a system-wide basis, to make sure that the workload rules for that workload groups are met. It is further able to identify bottlenecks in performance and allocate resources and or adjust throttles to alleviate the bottleneck. Also, it selectively deprives resources from a workload group that is idling system resources. In general, regulator 50 provides a single system view of meeting workload rules while the regulators 52 continue to support workload administration in a closed loop system environments.

It will be appreciated that the illustrated regulator 50 is capable of monitoring the performance and operational characteristics of a plurality of subsystems 53 across a domain 54. From this it provides a domain-wide approach to resource and performance management.

Although the present invention has been described with particular reference to certain preferred embodiments thereof, variations and modifications of the present invention can be effected within the spirit and scope of the following claims.

What is claimed is:

1. A system for managing a plurality of database systems, the system including:
an interface for obtaining data indicative of one or more operational characteristics of each of the database systems; and
a monitor that is responsive to the data for providing a signal indicative of an instruction to adjust one or more of the operational characteristics of a selected one of the database systems.

2. A system according to claim 1 wherein one or more of the database systems analyses its performance and inherently adjusts its respective operational characteristics in response to the analysis.

3. A system according to claim 2 wherein the analysis includes determining whether a particular class of queries are processed in accordance with one or more service level goals assigned to that class of queries.

4. A system according to claim 1 wherein one or more of the plurality of database systems make use of CLSM-type architecture.

5. A system according to claim 2 wherein one or more of the plurality of database systems includes a CLSM-type regulator.

6. A system according to claim 1 including:
an input for receiving a request from a user;
a processor responsive to the interface for selecting one of the databases to process the request, and
an output for providing the request to the selected database system for processing.

7. A system according to claim 6 wherein the processor categorizes the request into one of a plurality of predetermined workload groups, each workload group having respective service level goals.

8. A system according to claim 7 wherein the monitor is responsive to the workload groups for providing the signal.

9. A system according to claim 7 wherein the monitor is responsive to data indicative of whether particular service level goals are met for providing the signal.

10. A system according to claim 7 wherein the operational characteristics include an indication of the ability of a particular database to process a request belonging to a particular workload group in accordance with the service level goals of that workload group.

11. A system according to claim 10 wherein the signal is indicative of a command that affects the ability of a particular database system to process a request belonging to a particular workload group in accordance with the service level goals of that workload group.

12. A system according to claim 7 wherein the monitor is responsive to the respective workload groups of one or more queries received by the input for providing the signal.

13. A system according to claim 6 wherein the output provides the request in accordance with a predetermined query prioritization protocol.

14. A system according to claim 6 including a delay manager that selectively delays the provision of one or more requests to the selected database system in accordance with a predetermined selectively variable throttling protocol.

15. A system according to claim 1 wherein the operational characteristics include system resource consumption information.

16. A system according to claim 1 wherein the operational characteristics include request arrival rates.

17. A system according to claim 15 wherein arrival rates are adjusted by applying throttles.

18. A system according to claim 14 wherein each database system operated under one of a group of predetermined system resource consumption rules sets, and in response to the signal the selected database system adapts for operation under a different one of the group of predetermined system resource consumption rules sets.

19. A method for managing a plurality of database systems, the method including the steps of:
obtaining data indicative of one or more operational characteristics of each of the database systems; and
being responsive to the data for providing an instruction to adjust one or more of the operational characteristics of a selected one of the database systems.

20. A method for administering the workload of a plurality of database systems as one or more requests are received by a management system, the method including:
sorting the one or more requests into one or more workload groups, each workload group having an associated level of service desired from the database system;
selecting a database system to process the or each request to achieve the levels of service associated with each of the workload groups;
executing the one or more requests to achieve the levels of service associated with each of the workload groups;
assigning system resources of one or more of the database systems to the one or more workload groups as necessary to provide the level of service associated with each workload group;
monitoring the execution of requests to detect a deviation from the level of service greater than a short-term threshold and, if such a deviation is detected:
adjusting the assignment of system resources of one or more of the database systems to workload groups to reduce the deviation; and
monitoring on a long-term basis to detect deviations from the expected level of service greater than a long-term threshold, and if such a deviation is detected:
adjusting the execution of requests to better provide the expected level of service.
